(19) United States
(12) Patent Application Publication
(10) Pub. No.: US 2014/0093847 A1
(43) Pub. Date: Apr. 3, 2014

(54) AUTOMATED TEACHING SYSTEM USING DECLARATIVE PROBLEM SOLVING APPROACH

(71) Applicant: The Trustees of the Stevens Institute of Technology, Hoboken, NJ (US)

(72) Inventors: Alexei Miasnikov, West Milford, NJ (US); Alexey Myasnikov, Brooklyn, NY (US)

(73) Assignee: The Trustees of the Stevens Institute of Technolory, Hoboken, NJ (US)

(21) Appl. No.: 14/039,505

(22) Filed: Sep. 27, 2013

Related U.S. Application Data
(60) Provisional application No. 61/707,170, filed on Sep. 28, 2012.

(51) Int. Cl. G09B 23/02

(52) U.S. Cl. CPC G09B 23/02
USPC 434/188

(57) ABSTRACT

A system for solving problems in mathematics, natural science, engineering and like disciplines, online or on a computing device. The system includes an interface which employs a declarative approach to solution representation. The interface allows users such as students to enter their solutions by declaring main steps of a solution (in various modes and levels of detail). The interface provides a list from which a student selects an appropriate action and fills out the details of the computations related to the action. The system helps students learn the process of solving problems by teaching them how to divide solutions into logical steps.

### CROSS REFERENCE TO RELATED APPLICATIONS

The present application claims the benefit of U.S. Provisional Application No. 61/707,170, entitled, Interface for Declarative Problem Solver, filed Sep. 28, 2012, the disclosure of which is incorporated by reference herein in its entirety for all purposes.

### FIELD OF THE INVENTION

The present disclosure relates to a system for problem solving and teaching problem solving skills and techniques, and, more particularly, to a computer-based system for aiding students in learning problem solving skills and techniques, as well as assessing their learning progress, e.g., in a distance learning environment.

### BACKGROUND OF THE INVENTION

Current systems for teaching and testing problem solving, e.g., in the course of homework delivery and management make an assessment of whether the student has provided the correct answer. Alternative systems, including automated systems and methods for assessing student assimilation of knowledge and problem solving skills remain desirable.

### SUMMARY OF THE INVENTION

The disclosed subject matter relates to an automated teaching apparatus for teaching problem solving techniques to users, including a computer device programmed with teaching software capable of presenting a problem expressed as a problem statement to a user and allowing the user to solve the problem. The computer displays the problem statement to the user on a display under programmatic control and has an input mechanism enabling the user to select a portion of the problem statement. The program enables the user to conduct actions on the portion selected resulting in a processing of the portion selected and displaying a consequent state of the portion selected as an altered problem statement on the display. The problem statement and the altered problem statement constitute nodes on a solution path defined by the user, the programmed computer capable of enabling the user to select and process problem statements until the user has indicated completion of the user's solution path. The computer has access to stored data including the problem statement and to data defining a correct problem solution path having at least one node in addition to the problem statement, the computer checking the actions conducted by the user as the user attempts to solve the problem and evaluating whether the actions are correct or incorrect.

In accordance with another aspect of the disclosure, the programmed computer is capable of recording actions selected by the user and data indicating whether the action chosen by the user is correct or incorrect.

In accordance with another aspect of the disclosure, the computer has access to scoring data associated with correct and incorrect actions and is capable of rendering a cumulative score reflecting the correct and incorrect actions taken by the user in solving the problem.

In accordance with another aspect of the disclosure, the data accessed upon a user conducting an incorrect action includes a message displayed to the user.

In accordance with another aspect of the disclosure, the computer in response to an incorrect action presents the user with the option of selecting an action other than the incorrect action previously taken.

In accordance with another aspect of the disclosure, the computer is capable of presenting a plurality of alternative actions for processing a selected portion.

In accordance with another aspect of the disclosure, the alternative actions are presented in a menu.

In accordance with another aspect of the disclosure, the menu is populated based upon stored data accessible to the computer that is correlated to the selected portion.

In accordance with another aspect of the disclosure, the actions include at least one of arithmetic, algebraic, trigonometric and calculus functions.

In accordance with another aspect of the disclosure, the computer programmed with the teaching software is capable of operating in a problem preparation mode, wherein a supervisor defines a problem statement, nodes and actions leading to a solution of a problem.

In accordance with another aspect of the disclosure, the apparatus is capable of presenting a plurality of problems.

In accordance with another aspect of the disclosure, the data accessed in response to incorrect actions includes a remedial presentation of information to the user in the subject area in which the user chose an incorrect action.

In accordance with another aspect of the disclosure, the computer programmed with the teaching software permits the user to define the user's solution of a problem in a declarative manner.

In accordance with another aspect of the disclosure, the user in interacting with the programmed computer makes manual entries in solving the problem.

In accordance with another aspect of the disclosure, the actions recorded include logical steps in the solution of the problem and wherein the computer is capable of evaluating a user's ability to a solve a problem based upon the logical steps chosen by the user.

In accordance with another aspect of the disclosure, the selections and actions taken by a user in solving a problem on the computer may be selectively reversed to allow the user to make an alternative choice.

In accordance with another aspect of the disclosure, the alternative actions include both a correct and an incorrect action for solution of the problem.

In accordance with another aspect of the disclosure, the computer is at least one of a PC, a smartphone, a PDA and a server/host combination.

In accordance with another aspect of the disclosure, the program is at least partially running on a server computer communicating with a host computer connected to the server through a network.

In accordance with another aspect of the disclosure, the network is the Internet.

In accordance with another aspect of the disclosure, the computer programmed with the teaching software is capable of operating in an advanced solving mode, wherein a user is presented with a problem statement, makes selections, and chooses actions to define the user's solution of a problem, at least one of the actions being conducted automatically by the computer in accordance with programmed instructions enabled by a supervisor.

In accordance with another aspect of the disclosure, the automated actions are permitted by the supervisor based upon a demonstrated mastery of those actions by the user.

In accordance with another aspect of the disclosure, the computer programmed with the teaching software is capable of operating in a demonstration mode wherein the programmed computer traverses a problem solution pathway automatically, allowing a user to observe actions taken to solve a problem.

In accordance with another aspect of the disclosure, the user participates in the solution of the problem by making choices in how to solve the problem, the computer automatically providing feedback data in the case of incorrect choices by the user in solving the problem.

In accordance with another aspect of the disclosure, the computer programmed with the teaching software is capable of operating in a tutoring mode, wherein a user is presented with a problem statement, makes selections, and chooses actions to define the user's solution of a problem, a plurality of instructive messages stored as data and associated with actions, selections and nodes on a solution path being available to the user on the user's initiative to provide guidance as to making selections and taking actions in solving a problem.

In accordance with another aspect of the disclosure, the computer is capable of storing data corresponding to a plurality of solution paths for a given problem.

### BRIEF DESCRIPTION OF THE DRAWINGS

For a more complete understanding of the present disclosure, reference is made to the following detailed description of an exemplary embodiment considered in conjunction with the accompanying drawings, in which:

FIG. 1 is a work flow diagram for solving a problem in accordance with a first approach using a system in accordance with an embodiment of the present disclosure.

FIG. 2 is a work flow diagram for solving a problem in accordance with a second approach using a system in accordance with an embodiment of the present disclosure.

FIG. 3 is a work flow diagram for solving a problem in accordance with a third approach using a system in accordance with an embodiment of the present disclosure.

FIG. 4 is a screenshot of an exemplary declarative problem solver interface in accordance with an embodiment of the present disclosure.

### DETAILED DESCRIPTION OF THE EXEMPLARY EMBODIMENT

An aspect of the present disclosure is the recognition that “answer” based assessment of student problem solving skills provides limited utility in assessing student capabilities and limited guidance to teachers or teaching systems with respect to correcting and/or augmenting student problem solving approaches. An aspect of the present disclosure is to provide an automated system for conducting student assessment that: i) helps the instructor to understand theoretical gaps in a student's problem solving approaches as revealed by the structure of the steps taken in solving a given problem, which may have computational and/or conceptual mistakes, ii) gives partial credit for a solution that has correct aspects and incorrect aspects, iii) assesses the strategy of solving the problem, and iv) suggests targeted help for the student based upon the specific gaps in the student's problem solving approaches.

The present disclosure provides a system and a method for analyzing a solution to a problem in mathematics, natural science, engineering or any other discipline. For example, in one embodiment, the system provides an interface for solving problems in calculus. The interface allows a user, such as a student, to solve problems on-line or on a computer, at any given location, without the participation of a teacher. The system is scalable to any number of students and can be used by an effectively unlimited number of students simultaneously. The rate at which the system can respond to student interaction is effectively instantaneous and is limited only by the student's own capability. The system can record and report, analyze, summarize and/or score each action taken by a student as they solve a problem or set of problems. In accordance with one aspect of the present disclosure, students can build their solutions (solve a problem) step by step using functionality provided by a menu. The design of the user interface is based on visual components which are intuitive and easy to use.

The system provides a novel declarative approach to a solution representation. More particularly, students enter their solutions by declaring the main steps of a solution, together with various details such as computations, references, etc. To enter a solution, the student selects an appropriate action from a list provided by the interface and, if required, fills out the details of the computations related to the action.

The declarative structure of the solution allows an instructor to follow the logic of the solution path and determine the exact location where a mistake, if any, was made. This aspect of the system permits the assessment of important components of a learning system to allow giving partial credits, focused help and continuous monitoring of knowledge gaps in a student's learning progress.

The system enhances the learning process by teaching students how to divide solutions into logical steps and guides them in selecting appropriate steps for solving specific problems, which can then be projected to classes of similar problems. In one embodiment, the system provides targeted help when the solution is incorrect or not optimal. The system makes it possible to move away from “teaching by examples” and to increase the effectiveness of the learning process, because the system is based on the analysis of the solution process rather than the final answer.

The declarative problem solver interface can be operated in the following modes: i) “solving mode” for entering solutions by selecting appropriate actions from the interface menu, ii) “advanced solving mode” which includes a set of automated actions, iii) a “tutoring mode” in which students are allowed to ask for hints and solution suggestions, iv) “demonstration mode” which is completely automated and which shows the most appropriate step-by-step solution to a given problem, and v) “problem preparation mode” for entering problems and reference solutions to a given problem. As described below, in problem preparation mode, the supervisor/teacher defines the nodes of one or more solution paths that may be compared to the nodes of the solution path entered by the user during learning, testing or otherwise exercising the problem solver system.

The following is a list of definitions of terms that are used in the present disclosure.

1. User: a person who uses the system, for example, a student.

2. Supervisor: a person who supervises the educational process, for example, a professor.

3. Menu: a menu of options, e.g., functions or operations that may be performed on a given object or argument. The menu may be a dynamic, content-related menu, automatically generated by selection of an object. In one embodiment, a menu may have two parts, viz., a) a menu whose items depend on a set of selected objects and their types, and b) a static menu whose items depend on the problem type only, e.g., for a calculus problem, the static menu may contain: Create a new equation, create a new function, submit the final answer, etc.

4. Objects: any/all elements that state or represent an aspect of a given subject, such as a mathematical problem. For example, in calculus, objects may include numbers, variables, expressions, functions, equations, integrals, limits, derivatives, etc.

5. Selectable Objects: objects or their components (which may be “objects” themselves) that can be selected by the user to be acted on by a given function or operation that may be selected or entered. Selection can be performed by highlighting, double clicking or any other suitable method.

6. Selected Objects: selectable objects on the screen that are marked by the user as selected. There could be one or several selected objects (one can select several objects simultaneously).

7. Action: Performing a function or an operation, e.g., resulting in a new term, a predicate evaluation, term rewriting or a calculation. An action may be started by selecting an appropriate item from a dynamic or a static menu. An action may require information which is entering manually through an input window.

8. Operation: a pre-defined function or operation that can be performed on an object (for example, addition, multiplication, factoring, application of trigonometric functions, execution of standard formulas, function evaluation, differentiation, etc.).

9. Term creation: creation of a new specific object from a set of existing objects or from scratch according to specified rules and parameters.

10. Predicate evaluation: the action of ascertaining whether a specific predicate is true or false.

11. Term rewriting: term creation from a set of existing objects.

12. Calculation: execution of a specific sequence of steps.

13. Manual action: action which is conducted by a user, e.g., entry of a number or expression into a blank input field.

14. Automated action: action which is conducted by a computer procedure or an algorithm. Automated actions may require manual specification of some parameters. Automated actions may be allowed or disallowed by the supervisor.

15. Manual Input Window: a dialogue window for recording a user's input information which then can be used in a corresponding action.

16. Solution path: an ordered sequence of objects or sets of objects connected by one or more actions/functions which result in a given solution or answer. The solution path describes how a given answer was derived or achieved or how an intermediate answer (resultant object) was obtained from previous ones in the solution path. Typically, the first node in the sequence corresponds to a part (selectable object) in the statement of the problem. The last node in the solution path is called the final answer that may be specified by the user as terminating the solution path.

The following is a description of the functionality and workflow of four main modes of a declarative problem solver interface in accordance with one embodiment of the present disclosure. The problem solver interface is presented by a programmed computer either standing alone or connected to client computers via a network, such as the Internet, as described more fully below. The computer may have conventional peripheral devices, such as a keyboard, mouse and or touch screen for input and a display for output. Conventional computer devices, such as PCs, tablets, smartphones, and PDAs may be used to run the system software.

Solving mode is the main operational mode of the system. Other modes are either extensions of the solving mode or are using underling functionality and data obtained using the solving mode. When entering the solving mode, the user is presented with a problem statement. The problem statement may be authored/predetermined by a supervisor, e.g., a teacher or system administrator and entered into the system for storage in a database of problems for testing, homework, exercises, etc. The problem statement may contain selectable objects. For instance, a mathematical problem statement may be:

Compute a limit of a rational function:

$${lim}_{n -> 2} \frac{{x}^{2} - 4}{x - 2}$$

where the limit is selectable.

In the foregoing problem statement, the selectable objects are:

$${x}^{2} , {x}^{2} = 4 , x - 2 , \frac{{x}^{2} - 4}{x - 2} ,$$

etc. In response to this problem, the user may build/seek a solution by performing a sequence of actions (steps of the solution). The choice of which actions to take and the order of actions in the sequence are determined by the user. Each action results in a change of state, contributing to a sequence of states or nodes on a solution path where precedent and consequent states are connected by a corresponding action. This sequence represents the logical structure (a trace) of the solution. It is possible that more than one legitimate trace exists for a given problem and each legitimate trace may be accounted for by the system as described below with reference to problem preparation mode.

An action may be triggered by the user selecting one or several objects presented on the screen, e.g., by highlighting and double clicking on a portion or all of the objects in a problem statement. Other conventional methods of selecting, such as, highlighting and pressing ENTER or any other method used by the operating system of the computer, which may be, e.g., Windows, Mac OS, Linux or another operating system. In response to the selection of an object, the system analyzes the object by parsing the given mathematical expression into the formula tree in order to ascertain the type of object selected. In setting up the databases of the system, a table of object types and possible associated operations or functions that can be applied to those objects or to which the object may be passed as an argument is established. Identifying the type of object selected allows the system to look up the possible functions/operations that can be conducted on that object and the system may then present those possibilities to the operator as a menu of options. Since the options change based upon the object selected, menus presented upon selection of an object may be dynamic. For example, for the object “integer,” the corresponding functions are “factor,” “compute GCD,” “find the quotient,” “compute the remainder on division,” for the object “limit,” the corresponding functions are “apply limit laws (sum, difference, product, quotient),” “try to simplify,” “apply direct substitution,” “compute the limit,” “apply ('Hospital rule,” etc.

In the event that the user selects an object that is not in the database and the system does not recognize the object, the system may notify the user through a message, e.g., “The object is not recognized, please correct.” and allow the user to re-define the object selected. In the event that the object selected is of a valid type, the user is allowed to perform one of the actions/functions listed in the menu, which is populated and presented to the user. Upon the user selecting a given action/function to perform on the selected object by choosing it from the dynamic menu presented, the action is performed on the object by the system, yielding a new selectable object/(an intermediate answer), which is displayed to the user. More particularly, the menu of available actions/functions triggers a procedure which is provided with the selected object as the argument. Upon executing the procedure called by the menu selection, the procedure returns a processed object/intermediate answer, which may then be displayed to the user, such that the user can see the progress of problem solution and then consider the next step in processing or, in one alternative, may step back to try another action or to select another object.

In one approach, the system may review/compare the selected action/operation to a list of valid actions for the specific selected object and/or for the specific stage in the solution path for the specific problem. If an error is detected, a responsive message may be displayed to the user, such as, “The step is not recognized, please follow the hint.” in a message window. The supervisor knows in advance which actions/operations are suitable for any given object, as well as which actions are suitable to traverse a valid solution path or paths for a given problem. The system may optionally be set to present only suitable actions/functions for given objects or to present both suitable and unsuitable actions/functions for selection. When the user is allowed to select inappropriate functions from a menu of options, the system may optionally record and/or check each decision point by the user on the solution path and/or generate a suitable responsive/corrective message to the user upon the selection of an inappropriate option. The message may indicate the nature of the error and/or advise as to which option/menu choice(s) would be appropriate. This approach prevents the user from progressing down an erroneous solution path by notifying them at the point where they make a wrong choice. Optionally, the user may be presented with the option of revising their menu selection, that is, reversing or erasing the last menu selection and the intermediate answer (object) generated in response to the wrong menu selection. This approach may be utilized during instruction of a student. In the case of testing, the user may be allowed to proceed along a wrong path all the way to the wrong final answer without notification. Alternatively, the user may be provided with an opportunity to correct or revise their solution path under their own initiative.

In any of the foregoing approaches, the system may record the new object/intermediate answer in memory along with the selected function which generated it from the prior selected object, thus recording the steps of how a user has reached each stage in the solution of the problem. The recordation of the solution path taken by the user may be used by the system and/or the supervisor to generate a number grade for the solution path taken by the user or otherwise quantify the user's success in reaching a correct solution and/or mastery of required theoretical or calculated steps. In accordance with one embodiment, the supervisor may assign a point award associated with each stage of the solution path for a problem. The system may then tally points for each correct decision by the student for purposes of testing/evaluation of learning progress. In this regard, since early errors in a problem solution may prevent the user from demonstrating their knowledge of later steps, for assessment purposes, automatic checking and correction of each step may be utilized to provide the user with the opportunity to apply their knowledge of later steps for a given problem.

Optionally, the erroneous nodes, be they the results of incorrect selection of actions or incorrect calculation/manual entry of blank fill items, may be recorded, categorized and counted to trigger corresponding teaching content, e.g., a presentation of an automated example of correct problem solution covering the steps that were incorrectly performed by the user. Optionally, the incorrect steps taken and recorded may be utilized to generate a report to the supervisor/teacher to advise the teacher of the topics on which the user/student needs remediation or to trigger the display of remedial materials or demonstration(s).

Users may generate a new object by choosing the appropriate action from a static menu, wherein the definition and parameters, if any, are specified by the user manually. For example, the user selects from the static menu “create a new function,” the input window appears, and the user types “f(x)=2x+1.” As mentioned above, erroneous selections by the user, e.g., of menu options corresponding to functions/actions may be flagged and the user may be presented with the option of undoing the last action to return the system to the previous state. Since the system records each node traversed by a user, the system may optionally allow a user to retrace their steps back to a selected intermediate node or all the way back to the beginning of the solution path. In this manner, the user may execute various what-if scenarios and observe the consequences of various decisions in the solution path.

In advanced solving mode, the supervisor may turn on/off one or more advanced automated actions that allow students to perform calculations automatically using procedures and algorithms built in the system. Advanced automated actions can be used when the corresponding material is considered as having been already mastered by the student. For example, evaluation of a well-known function, such as the quadratic formula or trigonometric functions can be done automatically. This option allows students to reduce the time spent on routine computations and may decrease the number of computational mistakes, which otherwise, spoil the final results, but give no information on the level of the student's theoretical or high-level understanding of the material. The workflow in advanced solving mode is similar to the standard solving mode.

Tutoring mode is a solving mode (standard or advanced) where the user is allowed to request a hint from the system at each step. Hints are of three types:
1. When all previous steps are correct, the user may request advice on the next action. This requires that the supervisor has entered text data into the system database corresponding to the advice for each decision point on the solution path for the problem. Accordingly, when the system checks for a valid selection at a node and finds that the action selected is incorrect, the system may trigger the appropriate message for the node in question, teaching how the next node should be reached, if done correctly, or providing clues as to the proper action(s) to take to get beyond the previously incorrect selection.
2. In the case where there is more than one way to solve a problem, the system may measure the solution paths of the different solution methods to provide the most efficient path and order the alternative solution paths by efficiency. In the case where a solution step is correct but not optimal, the system may analyze the user's actions at each node and suggest a more optimal solution, either as that node is traversed or at the end of the solution path.
3. In one embodiment, in the instance where some of the previous steps were performed incorrectly, the system may identify incorrect steps and backtrack to the node on the solution path preceding the first erroneous action. The user may then be asked to continue the solution from this point.

Demonstration mode is invoked to show a user how to solve a problem of a particular type using passive and/or active demonstrations. In passive demonstration mode, the user selects a particular problem from a pool of problems and starts the demonstration run. The system displays the steps of the solution one-by-one with the details of the computation. Optionally, the system allows the user to switch to an advanced mode where some computational details are omitted. In active demonstration mode, the system tells the user to perform a sequence of actions to build the solution themselves. Each action is verified by the system and if the action was successfully performed by the user, then the next action is allowed. If the user has failed to perform a correct action, then the system provides an error analysis and gives the necessary help.

In problem preparation mode, the database of problems with their respective solution paths are initially defined, amended and/or expanded by the supervisor. The problem statement is entered using a problem statement editor, which allows a supervisor to input the text of a problem, define selectable objects and provides tools for editing and formatting. The supervisor may enter one or more solution paths using the solving mode by signaling to the system that the problem is being solved for reference purposes by a supervisor. The supervisor then proceeds to solve the problem by selecting objects and actions, the system executing the selected actions on the objects to yield a sequence of answer nodes defining a solution path. The supervisor may also define incorrect actions and the associated messages to be displayed to the user in a similar manner, i.e., by “solving” the problem incorrectly. All steps used in reaching the final answer are recorded and stored in a database accessible to the computer on which the system is implemented as reference steps/solutions/nodes. These reference nodes are subsequently used for the assessment of the user's solutions to the given problem. Supplementation and adjustments to the reference solutions may be done in the instance where a student finds a correct solution that cannot be traced according to the existing set of reference solutions.

Since a number of alternative methods may be utilized for solving a given problem, the supervisor may enter each of the plurality of solution paths known to him and each solution sequence can be recorded in the database, e.g., in an ordered list or array indexed by problem number or other identifier. When a user conducts problem solving, the proposed approaches of various users may be searched at each node in the solution path for a corresponding node in each of the several solution paths that are known to lead to a correct answer. The automated search of a large solution path database can be conducted effectively instantaneously for a large number of students utilizing a networked server computer or for a large number of students using the problem solver teaching system independently on their own personal computer or computing device. The result of this continuous fast checking of a user's problem solving will result in the student receiving instantaneous feedback.

The database in which the problem solution paths are stored may include fields indicating the lesson each problem belongs to, as well as the course, professor, school, user, presentation order/time, etc., allowing the system to select an appropriate problem(s) to present to a specific student who activates the system at a given time and date. The supervisor may also enter text messages to be displayed to the user that may be displayed either before or after the selection/entry of a given decision/selection of solution path node by the user. For example, upon the selection of an incorrect decision, the system may retrieve a remedial message from the solution path data structure and query the user if they wish to step back and try again.

The display of remedial messages and/or options to redo an incorrect step may be controlled by selection of a context variable by the supervisor, indicating the context of the user's use of the system. For example, the system may be used in the context of learning a new procedure wherein each step is explained prior to execution and wherein the user may step back is a mistake is made. In the context of testing, the supervisor may not wish to allow a message to be displayed prior to a user's first encounter with a given decision node. The remedial message may be set to be suppressed before and/or after the node during testing to see what the student knows. Another context or mode is demonstration mode, wherein the user may receive all lesson messages or upon the demonstration of having assimilated a given subject, the system will skip messages covering the mastered material. In describing the solution path during problem preparation mode, the supervisor will define all properly selectable objects and all proper actions. These may be stored in lists, arrays, associated/indexed with each node and may be invoked to populate menus when at a node requiring action selection or to be checked when a user is required to select an object for the next application.

An embodiment of the present disclosure allows new problem types to be added to the system. “Problem type” means the problem statement where the particular objects (constants, functions, etc.) are replaced with parameters from a suitable range. For example, for the problem “Differentiate the function x²−2x−2,” one of the problem types is “Differentiate the function x²+ax+b”, where a ranges from −5 to 5, and b ranges from −10 to 10″

$$lim n -> 2 \frac{{x}^{2} - 4}{x - 2} . ''$$

The following is an example showing a workflow when solving a problem using a declarative problem solving interface in accordance with an embodiment of the present application. Assume a student is provided with the problem statement 10 of computing the limit of a rational function:

$${lim}_{n -> 2} \frac{{x}^{2} - 4}{x - 2}$$

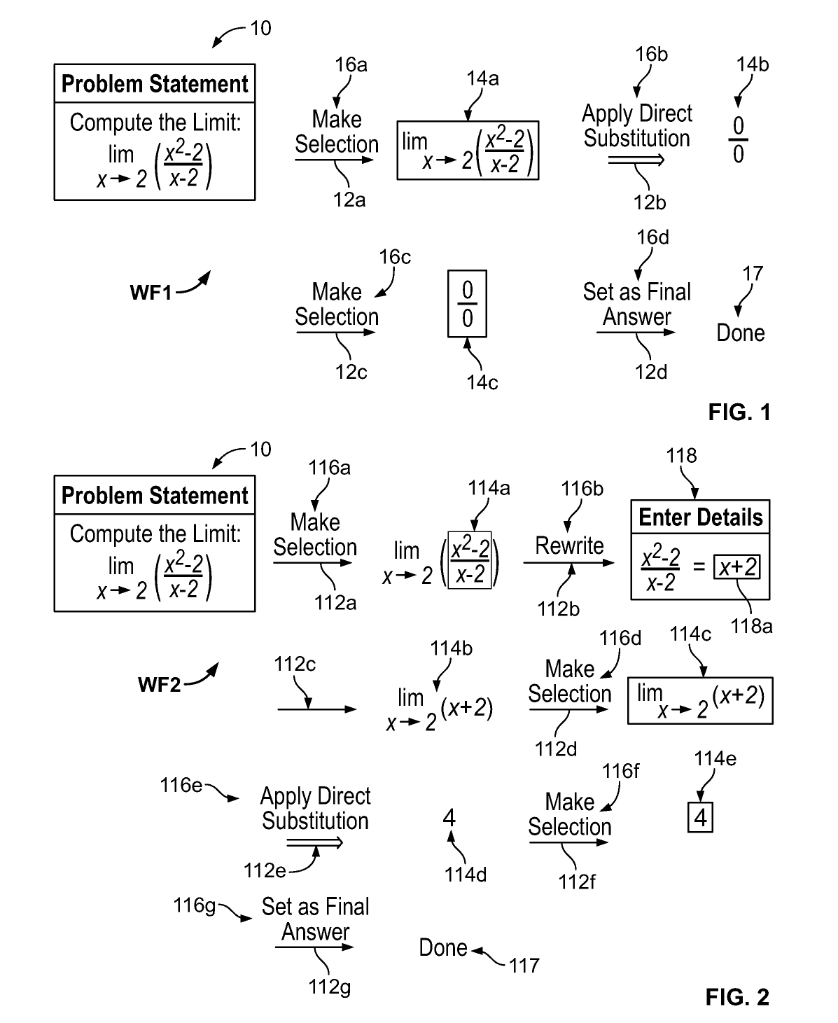

There are several ways that a student may proceed in order to construct a correct solution. Three different workflows WF1-WF3 (solution paths) are shown in FIGS. 1-3, two of which result in correct solutions and one of which results in an incorrect “solution.” This is a simple example and chosen to demonstrate the functionality of the system. In FIGS. 1-3, arrows 12a, 12b, 12c, 12d represent user actions, and expressions 14a, 14b, 14c are the sequence of states/nodes presented on the computer display screen. Single arrows 12a, 12c, 12d correspond to manual actions 16a, 16c, 16d where all details must be completed by the user, and double arrows 12b correspond to automated actions 16b where a result is computed automatically. Bold font (see 16b and 16d) is used to distinguish declarative actions, i.e., the substantive steps of the solution that are selected from the object's menu. The “Make selection” user action 16a, 16c is implemented by highlighting a selectable object (part of the formula) from the problem statement 10 or from an intermediate answer, e.g., 14b. Whenever an action is invoked, it is assumed that it is applied with respect to a selected object, e.g., 14a, 14c encapsulated in a shaded region in the expression directly preceding the action.

Typically, the first step when solving the problem 10 given in FIG. 1 is to identify whether the limit point is in the function domain. If it is, then the problem is solved by a simple method of direct substitution. The sequence described in FIG. 1 represents a naïve, incorrect solution to the problem 10. The following describes in detail the steps in the sequence shown in FIG. 1. Starting with a statement of the problem 10 where the mathematical expression contains selectable objects, such as all or part of the mathematical expression, the user makes a selection by highlighting the whole expression of the limit (the formula is in the shaded box 14a). The menu (not shown) lists all possible actions applicable to limits of this type, e.g., substitution rule, quotient rule and rewrite. This list of menu choices includes the action, “Apply direct substitution.” The user selects “Apply direct substitution” 16b from the menu, which is an automated action that provides the result 14b of 0/0, which is displayed on a screen of the computer used by the user. At this point, a knowledgeable student should realize that the problem cannot be evaluated further and would backtrack or restart the solution. FIG. 1 shows an example of when a student does not realize that 0/0 is not defined and continues by submitting that as the final (incorrect) answer. More particularly, the student selects 0/0 (at 14c) on the screen. The menu with items applicable to this selection appears, e.g., select as the final answer, rewrite, try to simplify, etc., and the student chooses “Set as the final answer” 16d from the menu and submits the solution 12d. Once the solution is submitted, the corresponding chain of objects and actions is recorded for the further analysis. In the example shown in FIG. 1, this sequence may be recorded as a tuple:

$$( {lim}_{n -> 2} \frac{{x}^{2} - 4}{x - 2} , '' Direct substitution '' , \frac{0}{0} )$$

Here it is understood that the final answer was obtained from the limit expression by direct substitution. The answer is incorrect and one can detect the point of error in the solution. A correct solution will involve algebraic manipulations simplifying the rational function in a such way that the limit point 2 is contained in the domain of the limit function.

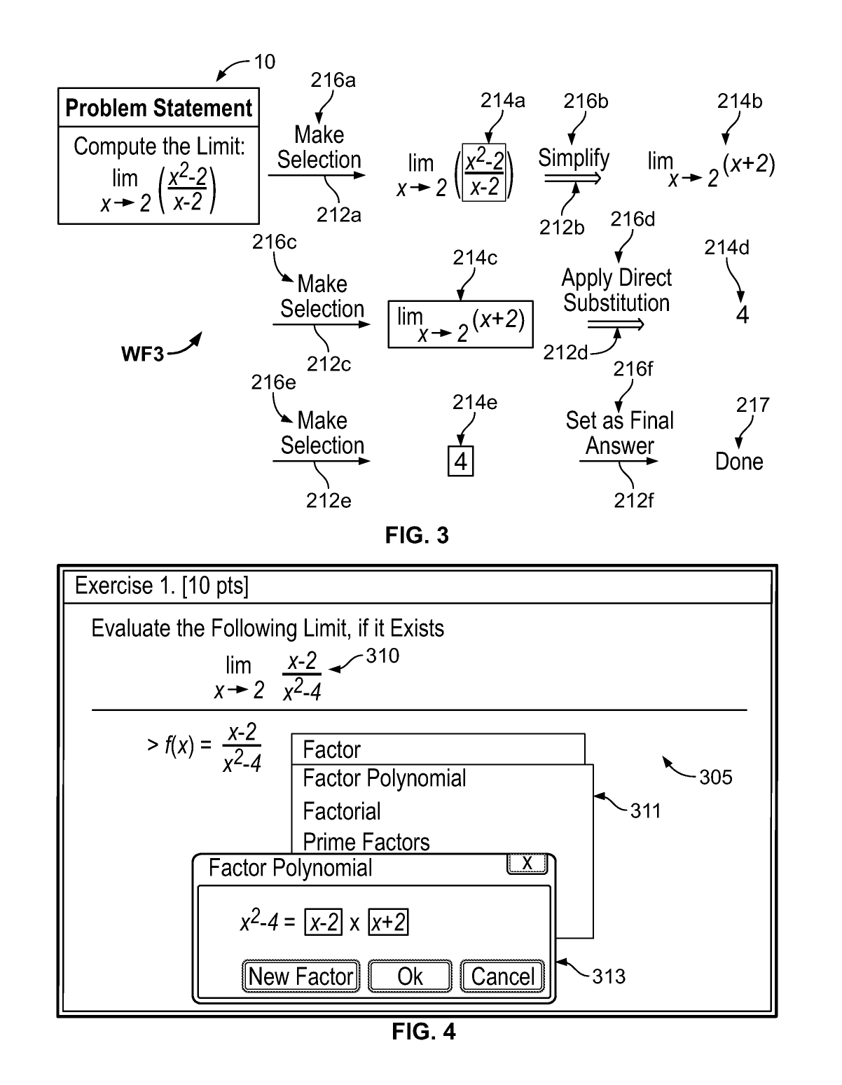

FIGS. 2 and 3 show two alternative solution paths WF2 and WF3, one involving manual simplification of the function and the second using simplification by automated action. In both cases, one starts with the problem statement 10. Then the sequence described in FIG. 2 is as follows: The user selects 116a the rational function 114a inside the limit of the problem statement 10. The user selects “Rewrite” 116b from the menu associated with functions. Rewrite is a manual action. A window 118 requiring manual input of the action details appear. In this case, the user enters the expression 118a equivalent to the selected function. A limit object 114b with a new expression (x+2) appears on the screen. At this point the user can try to apply direct substitution. The user highlights the limit object 114c and selects “Apply direct substitution” 116e from the menu. The system computes the value “4” automatically at 114d. The user highlights the number “4” at 114e and marks it 116g as a final answer, whereupon “DONE” is displayed 117.

This is a correct solution and the corresponding sequence is:

$$( {lim}_{n -> 2} \frac{{x}^{2} - 4}{x - 2} , '' Rewrite '' , {lim}_{n -> 2} ( x + 2 ) , '' Direct substitution '' , 4 ) .$$

Finally, the steps of the solution path WF3 depicted in FIG. 3 are the following: the user selects the rational function 214a inside the limit. The user then selects “Simplify” 216b from the menu associated with rational functions. Note that this is an automated action and would have to be allowed by the supervisor (professor) in order to be available for students. The simplified expression 214b of the limit object automatically appears on the computer screen. The user highlights the limit object at 214c and selects “Apply direct substitution” 216d from the menu. The system computes the value “4” automatically. The user then highlights the number 4 at 214e and marks it as a final answer 216f.

The corresponding sequence is:

$$( {lim}_{n -> 2} \frac{{x}^{2} - 4}{x - 2} , '' simplify '' , {lim}_{n -> 2} ( x + 2 ) , '' Direct substitution '' , 4 ) .$$

In FIG. 4, we show an example of the interface screenshot 305, which includes the problem statement 310, a menu 311 and an input window 313.

Once a solution is entered and submitted, the user's answer is then evaluated, the system performing the following steps. The solution is parsed and each step in the solution path is represented in the standard (unique) normal form. For example, (x+1)(x+1), (x+1)², and x²+2x+1 are represented by a polynomial given in the normal form as a tuple (1,2,1). The solution itself is represented by an ordered sequence of pairs, each containing the step declaration and the corresponding normal form that describes all the details of the step. The system determines whether the solution is correct or not, which is done with the use of the corresponding problem derivation structure. If the solution is incorrect, the system determines the step where a mistake was made and stores this information to be used later for focused help.

The automated system of the present disclosure may be implemented on a variety of computer hardware configurations. For example, the system and data may be downloaded in whole or part to a stand-alone computer, such as a PC or a Smartphone. Alternatively, the system may be installed on a server computer attached to a network, such as the Internet and made available in whole or part to users, supervisors and administrators using host computers connected to the network. The system may use passwords to control access to the system and there may be several layers of access, e.g., for programmers, administrators, supervisors/teachers, and users/students. The automated system of the present disclosure may be expressed in a variety of programming languages, such as, Java, Javascript, C, C++, Python, etc. The data structures employed may include graphs, trees, etc.

Implementation of the modes of the system of the present disclosure is data intensive, but may also utilize significant mathematical/arithmetic computation, e.g., in the instances of solving complex mathematical problems like solving multivariate equations, evaluating integrals or in calculating number intensive scientific or engineering problems, e.g., as would be encountered in deciding if two given mathematical expressions define the same function or not.

It will be understood that the embodiment described herein is merely exemplary and that a person skilled in the art may make many variations and modifications without departing from the spirit and scope of the present disclosure. All such variations and modifications are intended to be included within the scope of the disclosure.

We claim:

1. An automated teaching apparatus for teaching problem solving techniques to users, comprising:
a computer device programmed with teaching software capable of presenting a problem expressed as a problem statement to a user and allowing the user to solve the problem, the computer displaying the problem statement to the user on a display under programmatic control, the computer having an input mechanism enabling the user to select a portion of the problem statement, the program enabling the user to conduct actions on the portion selected resulting in a processing of the portion selected and displaying a consequent state of the portion selected as an altered problem statement on the display, the problem statement and the altered problem statement constituting nodes on a solution path defined by the user, the programmed computer capable of enabling the user to select and process problem statements until the user has indicated completion of the user's solution path, the computer having access to stored data including the problem statement and to data defining a correct problem solution path having at least one node in addition to the problem statement, the computer checking the actions conducted by the user as the user attempts to solve the problem and evaluating whether the actions are correct or incorrect.

2. The apparatus of claim 1, wherein the programmed computer is capable of recording actions selected by the user and data indicating whether the action chosen by the user is correct or incorrect.

3. The apparatus of claim 2, wherein the computer has access to scoring data associated with correct and incorrect actions and is capable of rendering a cumulative score reflecting the correct and incorrect actions taken by the user in solving the problem.

4. The apparatus of claim 2, wherein the data accessed upon a user conducting an incorrect action includes a message displayed to the user.

5. The apparatus of claim 4, wherein the computer in response to an incorrect action presents the user with the option of selecting an action other than the incorrect action previously taken.

6. The apparatus of claim 1, wherein the computer is capable of presenting a plurality of alternative actions for processing a selected portion.

7. The apparatus of claim 6, wherein the alternative actions are presented in a menu.

8. The apparatus of claim 7, wherein the menu is populated based upon stored data accessible to the computer that is correlated to the selected portion.

9. The apparatus of claim 1, wherein the actions include at least one of arithmetic, algebraic, trigonometric and calculus functions.

10. The apparatus of claim 1, wherein the computer programmed with the teaching software is capable of operating in a problem preparation mode, wherein a supervisor defines a problem statement, nodes and actions leading to a solution of a problem.

11. The apparatus of claim 1, wherein the apparatus is capable of presenting a plurality of problems.

12. The apparatus of claim 5, wherein the data accessed in response to incorrect actions includes a remedial presentation of information to the user in the subject area in which the user chose an incorrect action.

13. The apparatus of claim 1, wherein the computer programmed with the teaching software permits the user to define the user's solution of a problem in a declarative manner.

14. The apparatus of claim 13, wherein the user in interacting with the programmed computer makes manual entries in solving the problem.

15. The apparatus of claim 13, wherein the actions recorded include logical steps in the solution of the problem and wherein the computer is capable of evaluating a user's ability to a solve a problem based upon the logical steps chosen by the user.

16. The apparatus of claim 15, wherein the selections and actions taken by a user in solving a problem on the computer may be selectively reversed to allow the user to make an alternative choice.

17. The apparatus of claim 7, wherein the alternative actions include both a correct and an incorrect action for solution of the problem.

18. The apparatus of claim 1, wherein the computer is at least one of a PC, a smartphone, a PDA and a server/host combination.

19. The apparatus of claim 18, wherein the program is at least partially running on a server computer communicating with a host computer connected to the server through a network.

20. The apparatus of claim 19, wherein the network is the Internet.

21. The apparatus of claim 1, wherein the computer programmed with the teaching software is capable of operating in an advanced solving mode, wherein a user is presented with a problem statement, makes selections, and chooses actions to define the user's solution of a problem, at least one of the actions being conducted automatically by the computer in accordance with programmed instructions enabled by a supervisor.

22. The apparatus of claim 21, wherein the automated actions are permitted by the supervisor based upon a demonstrated mastery of those actions by the user.

23. The apparatus of claim 1, wherein the computer programmed with the teaching software is capable of operating in a demonstration mode wherein the programmed computer traverses a problem solution pathway automatically, allowing a user to observe actions taken to solve a problem.

24. The apparatus of claim 23, wherein the user participates in the solution of the problem by making choices in how to solve the problem, the computer automatically providing feedback data in the case of incorrect choices by the user in solving the problem.

25. The apparatus of claim 1, wherein the computer programmed with the teaching software is capable of operating in a tutoring mode, wherein a user is presented with a problem statement, makes selections, and chooses actions to define the user's solution of a problem, a plurality of instructive messages stored as data and associated with actions, selections and nodes on a solution path being available to the user on the user's initiative to provide guidance as to making selections and taking actions in solving a problem.

26. The apparatus of claim 1, wherein the computer is capable of storing data corresponding to a plurality of solution paths for a given problem.
